(19) United States
(12) Patent Application Publication
(10) Pub. No.: US 2013/0036353 A1
(43) Pub. Date: Feb. 7, 2013

(54) Method and Apparatus for Displaying Multimedia Information Synchronized with User Activity

(71) Applicants: Eric Zavesky, Hoboken, NJ (US); Bernard S. Renger, New Providence, NJ (US); Andrea Basso, Marlboro, NJ (US); Lee Begeja, Gillette, NJ (US); David C. Gibbon, Lincroft, NJ (US); Zhu Liu, Marlboro, NJ (US); Behzad Shahraray, Holmdel, NJ (US)

(72) Inventors: Eric Zavesky, Hoboken, NJ (US); Bernard S. Renger, New Providence, NJ (US); Andrea Basso, Marlboro, NJ (US); Lee Begeja, Gillette, NJ (US); David C. Gibbon, Lincroft, NJ (US); Zhu Liu, Marlboro, NJ (US); Behzad Shahraray, Holmdel, NJ (US)

(73) Assignee: AT&T INTELLECTUAL PROPERTY I, L.P., Atlanta, GA (US)

(21) Appl. No.: 13/204,193

(22) Filed: Aug. 5, 2011

(51) Int. Cl. G06F 3/00

(52) U.S. Cl. 715/716

(57) ABSTRACT

A method, apparatus, and computer readable medium for displaying multimedia information synchronized with user activity includes a multimedia processing unit. The multimedia processing unit receives requests for multimedia information from a user and synchronizes the display of a multimedia presentation to a user based on user activities which are observed using one or more sensors. The multimedia processing unit acquires multimedia information from various sources via a network and segments the multimedia information based on content and additional information determined to be related to particular multimedia information acquired. The multimedia processing unit generates multimedia presentations using multimedia segments obtained from different sources. Multimedia segments are selected for a particular multimedia presentation based on a rating associated with the multimedia information from which the segment was derived.

### FIELD OF THE DISCLOSURE

The present disclosure relates generally to the presentation of information, and more particularly to the display of multimedia information synchronized with user activity.

### BACKGROUND

A large amount of multimedia information is available concerning a variety of subjects. Included in this information are instructional materials such as how to videos, which provide information such as how to perform a task, and lectures concerning various topics. These instructional materials are often delivered at a fixed pace, for example, a video playing at a fixed pace (i.e. the pace at which the video was recorded). If a user wants or needs more information concerning a portion of the information delivered, the user must search for the additional information.

The multimedia information available includes a spectrum of material ranging from good, helpful, informative material to bad or unhelpful material. A user can determine if particular information is considered good or bad by reviewing other peoples' criticism associated with the information. For example, various sources providing information allow viewers to rate the information. An average rating for a particular piece of information may be determined using the ratings provided by multiple viewers. The average rating of a particular piece of information provides a potential viewer with an indication of other viewers' regard for the particular piece of information.

Viewers may also provide comments regarding the information. Comments can range from short entries indicating appreciation of the information to long critiques and lengthy comments.

Particular portions of a particular piece of information may be considered good or bad by a particular viewer, however, the average rating of the information typically indicates only a group of viewers' rating of the particular information overall. A user may have to view multiple pieces of information in order to obtain knowledge of each step of a particular process since different pieces of information may contain different portions that are considered good or correct according to most viewers or a designated expert.

### BRIEF SUMMARY

In one embodiment, a method for displaying a multimedia presentation to a user comprises presenting the multimedia presentation to the user. User activity (e.g., user motion and speech, auditory information, manipulation of objects, and visual scenes) is sensed and compared to metadata associated with the multimedia presentation. The multimedia presentation is adjusted based on the comparing. In various embodiments, the adjusting comprises synchronizing a playback rate (also referred to as a display rate) of the multimedia presentation to the user activity and presenting additional content to the user. Additional content may comprise video and audio of another user viewing the multimedia presentation. The multimedia presentation may be comprised of a plurality of segments wherein each of the segments is selected based on a rating associated with each of the plurality of segments. The ratings for the segments can be based on a level of trust associated with a provider of each of the plurality of segments.

An apparatus for performing the above method and a computer-readable medium storing instructions for causing a computing device to perform operations similar to the above method are also disclosed.

These and other advantages of the general inventive concept will be apparent to those of ordinary skill in the art by reference to the following detailed description and the accompanying drawings.

### BRIEF DESCRIPTION OF THE DRAWINGS

FIG. 1 shows a system for synchronizing the display rate of a multimedia presentation to a user based on user activity;

FIG. 2 is a flowchart showing a method for use with the system of FIG. 1;

FIG. 3 is a flowchart showing a method for use with the system of FIG. 1 in which the display rate of a multimedia presentation is synchronized to a user based on user activity;

FIG. 4 is a flowchart showing a method for use with the system of FIG. 1 for identifying and segmenting multimedia information into a plurality of segments;

FIG. 5 is a flowchart showing a method for use with the system of FIG. 1 for generating a multimedia presentation comprised of a plurality of multimedia segments; and

FIG. 6 is a high-level block diagram of a computer for implementing a multimedia processing unit and the methods of FIGS. 2, 3, 4, and 5.

### DETAILED DESCRIPTION

Systems and methods disclosed herein pertain to generation and presentation of multimedia information to a user, wherein, in one embodiment, the multimedia information is a multimedia presentation which pertains to a particular topic or procedure. The playback or display of a multimedia presentation to a user is paced or synchronized with user activity based on observations made during the display of the multimedia presentation. The multimedia presentation, in one embodiment, is generated by selecting and using segments of multimedia information from multiple sources of multimedia information and additional material or content. Each of the segments of multimedia information contained in a particular multimedia presentation may be selected, in one embodiment, based on viewer ratings of each segment. Segments of multimedia information may also be selected based on a level of trust associated with the user who generated or provided the multimedia information associated with a particular segment. Multimedia generally refers to information that contains two or more forms of media such as video media and accompanying audio media. However, the term “multimedia” as used herein may also refer to information that consists of a single form of media such as audio only, video only, image only, and text. In one embodiment, the user can initiate the selection of multimedia content that satisfies the user's interest or the system can detect from the user's behavior what content of interest is desired.

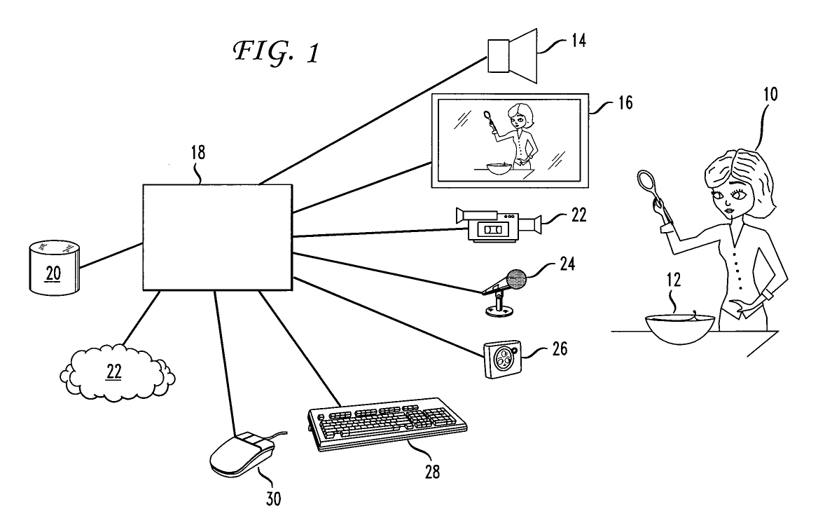

FIG. 1 shows a schematic of a system for displaying multimedia information as a multimedia presentation to a user in which the multimedia presentation displayed is synchronized or displayed at a pace based on the user's activities observed using sensors while the multimedia presentation is displayed. User 10 is shown performing an activity involving object 12, which, in this example, is a mixing bowl. User 10 observes multimedia information via display 16 and speaker 14, each of which is connected to multimedia processing unit 18.

Multimedia processing unit 18 is configured to present information retrieved from database 20 which stores various kinds of information such as multimedia presentations. A multimedia presentation, in one embodiment, is presented synchronized with user activity observed via sensors such as camera 22, microphone 24, motion sensor 26, keyboard 28, and mouse 30, each of which is shown connected to multimedia processing unit 18. Camera 22 is used to capture images of user 10 as well as objects, such as object 12, and the environment in which the user is currently located. Microphone 24 is used to receive ambient sounds including the voice of user 10. Keyboard 28 and mouse 30 can be used to receive input from user 10 while motion sensor 26 can be used to acquire motion and distance information. Motion sensor 26 can, for example, detect one or more user gestures or movements as well as the location of objects as described further below. Although not shown in FIG. 1, other sensors may be used as well, for example range sensors, location sensors, environmental sensors, infrared, temperature, wind speed, and other transducers for converting various parameters into signals suitable for input to multimedia processing unit 18. The sensors can be used in various combinations depending on factors such as user preferences, cost constraints, etc. Multimedia processing unit 18 is in communication with database 20 and can retrieve multimedia information for presentation to a user as described further below. Multimedia processing unit 18 is also in communication with network 22 through which multimedia processing unit 18 can acquire multimedia information from various sources such as individual users, content providers, businesses, as well as additional content available from the Internet. Multimedia information can be presented to user 10 via display 16 and speaker 14. Although not shown in FIG. 1, additional devices may be used to present multimedia information to a user. For example, a relatively complex delivery of multimedia information can use various devices to present the multimedia information to a user as a virtual reality.

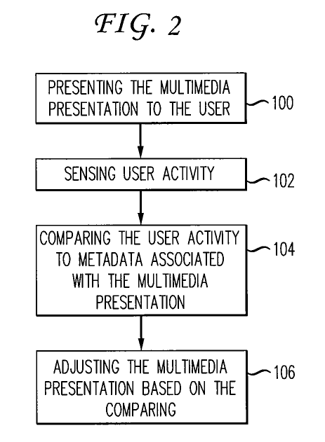

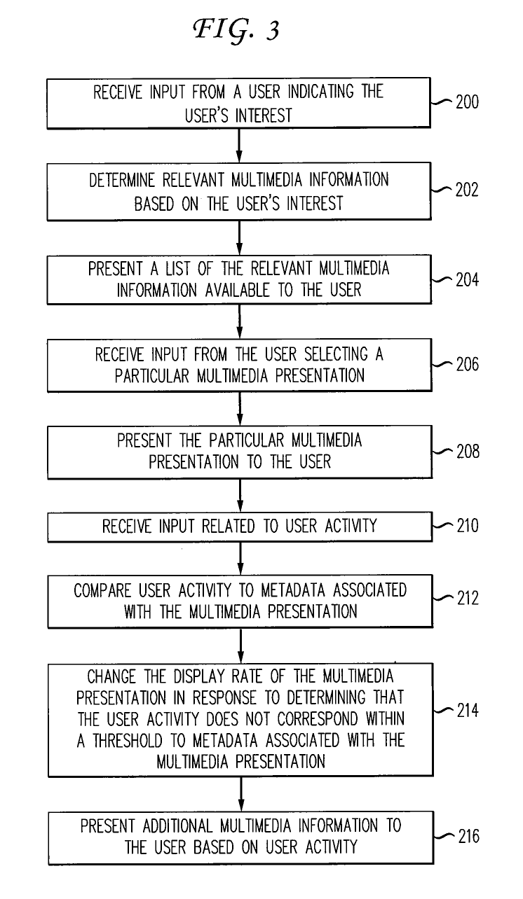

FIG. 2 shows an overview of a method according to one embodiment in which a multimedia presentation is displayed to a user and adjusted based on user activity. At step 100, multimedia processing unit begins presenting the multimedia presentation to the user via display 16 and speaker 14. At step 102, multimedia processing unit 18 senses user activity using one or more of sensors 22-30. At step 104, multimedia processing unit 18 uses the sensed user activity in comparing the user activity to metadata associated with the multimedia presentation. At step 106, multimedia processing unit 18 may change the output via display 16 and speaker 14 by adjusting a display rate of the multimedia presentation based on the comparing. The method shown in FIG. 2 is described in further detail below in conjunction with FIGS. 3-5.

FIG. 3 shows a method according to one embodiment in which a user selects a multimedia presentation to view and the multimedia presentation displayed is paced or synchronized with observed user activity. The method begins at step 200 in which multimedia processing unit 18 receives input from a user regarding the user's interest. Specifically, the input from the user indicates the multimedia information the user is interested in and wants to view. The user can input a question or query explicitly using keyboard 28 and/or mouse 30, verbally using microphone 24, by using gestures which are observed by camera 22 and motion sensor 26, or combinations of inputs. For example, a user can enter a question or one or more keywords to search for information pertaining to a particular topic or provide a question or one or more keywords verbally. Multimedia processing unit 18 can also determine multimedia information a user wants by analyzing user activity observed via camera 22, microphone 24, and motion sensor 26 as well as other inputs.

At step 202, multimedia processing unit 18 determines relevant multimedia information based on the user's interest. Specifically, the user's input is analyzed by multimedia processing unit 18 to determine the user's request and also determine the relevant multimedia information. For example, if a user orally states “How do I make a cake?” the verbal input received via microphone 24 may be converted to text and the text then analyzed by multimedia processing unit 18 to determine multimedia information related to making a cake is desired. Multimedia processing unit 18 searches database 20 for information relevant to the user's question. Relevant multimedia information may also be determined based on a user profile.

A user profile, in one embodiment, is created by a user and contains various information pertaining to a user's interests and preferences. A user profile can include demographic information, user preferences for multimedia (e.g., video, images, or audio), preferred and/or trusted users, minimum ratings for identified content, as well as combinations of parameters. For example, for cooking, a user may specify that only video multimedia is of interest and images should not be listed in search results. It should be noted that searches for relevant multimedia information may be based on a combination of current user input as well as user profile information.

At step 204, multimedia processing unit 18 presents a list of the relevant multimedia information available to the user as determined in step 202. In one embodiment, the list of relevant multimedia information is presented to a user on display 16. At step 206, multimedia processing unit 18 receives input from the user selecting a particular multimedia presentation. The user may select a particular multimedia presentation from the list using keyboard 28, mouse 30, or other interface such as microphone 24 or camera 22 and/or motion sensor 26. In one embodiment, after relevant information is determined at step 202, the system automatically begins presenting the most relevant multimedia information based on one or more of associated ratings of the multimedia content, a user profile, and interests associated with the user.

Multimedia processing unit 18 can also request a user to further define or narrow the user's search or question in order to provide more specific information. For example, in response to a user asking “how do I make a cake?” multimedia processing unit 18 may request the user to specify the type of cake the user wants to make. The request from multimedia processing unit 18, in one embodiment, is in the form of a list presented to the user of the types of cakes a user can make. Interaction between user 10 and multimedia processing unit 18 can continue until user 10 identifies the desired multimedia information in relation to the specificity of information available.

At step 208, multimedia processing unit 18 presents the particular multimedia presentation to the user. A user selecting multimedia information concerning how to make a cake may be presented with audio/visual multimedia presentation instructing a viewer how to make a cake. The multimedia presentation is presented to the user at a default display rate. For example, for a prerecorded video, the video may be displayed at the original rate at which the video was recorded.

At step 210, multimedia processing unit 18 receives input related to user activity. More specifically, user activity is sensed using one or more sensors, such as camera 22, microphone 24, motion sensor 26, keyboard 28, and mouse 30. At step 212, multimedia processing unit 18 compares user activity to metadata associated with the multimedia presentation. For example, user activity observed via inputs from the sensors, such as motion sensor 26, may be analyzed to determine what physical activity the user is currently performing.

At step 214, multimedia processing unit 18 changes the display rate of the multimedia presentation in response to determining that the user activity does not correspond within a threshold to metadata associated with the multimedia presentation. If the user activity observed matches the metadata associated with the displayed multimedia information within a threshold, the display rate of the multimedia information is not changed. If the user activity observed does not match the metadata associated with the displayed multimedia information within the threshold, the display rate of the multimedia information is changed to more closely correspond to the observed user activity at step 210.

In one embodiment, user activity is computed using one or more of input sensors (e.g., camera 22, microphone 24, motion sensor 26, etc.) and techniques that can derive specific (but repeatable) activities. Metadata may be similarly computed using similar techniques to analyze multimedia content. For example, the activity of chopping vegetables can be determined using information received from camera 26 and motion sensor 26. The activity of tenderizing meat can be determined using the sounds of a mallet impact received by microphone 24 and the motion of the mallet swing received by motion sensor 26. The activity of turning on an electronic device can be determined using information received by camera 22 such as the illumination of an “on” light or a start-up screen. Each determined activity can be numerically represented as a single value or numerical vector of metadata by processing and quantizing inputs from sensors. Distances between this numeric metadata (and consequently their original user-based actions) can be computed in the multimedia processing unit 18 and deviations beyond a threshold that is pre-determined for that multimedia and possibly dynamically adjusted for each user.

At step 216, multimedia processing unit 18 presents additional multimedia information to the user based on user activity. For example, when multimedia information pertaining to how to make a cake shows the step of breaking eggs and placing the contents of the eggs in a bowl, additional multimedia information pertaining to a different method for breaking eggs is presented to the user in addition to the multimedia information pertaining to how to make a cake. Steps 208-216 are repeated until the multimedia presentation displayed is complete.

To aid in understanding the method shown in FIG. 3, the following is an example in which a user wants multimedia information concerning how to make a cake. In this example, display 16, speaker 16, camera 22, microphone 24, motion sensor 26, keyboard 28, and mouse 30 are located in a user's (e.g., user 10) kitchen.

At step 200 the user enters a query using one of inputs such as microphone 24, motion sensor 26, keyboard 28, and mouse 30. For example, a user may enter the question “How do I make a cake?” using keyboard 28. Alternatively, user 10 may verbally ask “How do I make a cake?” which is received by microphone 24 and processed by multimedia processing unit 18 to determine the user's verbal input. At step 202, multimedia information processing unit 18 determines relevant multimedia information by searching for relevant information related to the user's query in database 20 which stores multimedia information. If a user's query is not specific or more than one piece of multimedia information matches a user's query, the user will be presented with a list of the relevant multimedia information found in database 20 at step 204. In one embodiment, the user may be requested to provide additional information in order to narrow down the corresponding amount of relevant multimedia information. In this example, the user is asking how to make a cake and multimedia information pertaining to making different types of cakes is contained in database 20. The user is presented with a list of the multimedia information pertaining to how to make the different types of cakes available from database 20.

In the present example, at step 206 the user selects multimedia information pertaining to an Angel food cake from the list of relevant multimedia information using one of the available inputs such as keyboard 28, mouse 30, or microphone 24.

In response to the user selection, multimedia processor 18 begins displaying a multimedia presentation corresponding with the user's selection of Angel food cake at step 208. The multimedia presentation, in this example, is an instructional video showing a user how to make an Angel food cake from scratch. At step 210, as the multimedia information is presented, multimedia processing unit 18 receives input related to user activity observed using one or more of input devices 22-30.

At step 212, multimedia processor 18 compares the observed user activity to metadata associated with the multimedia information concerning the activity currently displayed in the instructional video being presented. At step 214, the display rate or pace of the presented multimedia is adjusted depending on whether the observed user activity lags behind the displayed information or if the observed activity leads the displayed information within a threshold. For example, if the first step of the instructional video displayed is breaking open eggs and placing the contents of the eggs into a bowl, multimedia processing unit 18 analyzes the observed user activity to determine if the user is currently breaking eggs and placing them in a bowl. If the user is performing the activity corresponding to the metadata associated with the multimedia information currently displayed within a threshold, then the displayed rate or pace of the video is left unchanged. If the user is not performing the activity corresponding to the multimedia information currently displayed within a threshold, then the display rate of the video is slowed or stopped.

At step 216, multimedia information processor 18 provides additional multimedia information to the user based on the observed user activity. For example, if the user is not breaking eggs and placing the contents of the eggs into a bowl, multimedia information processor 18 can provide additional multimedia information concerning the specific activity the user is expected to perform corresponding to the metadata associated with the displayed multimedia information. Additional multimedia information stored in database 20 can be presented such as what an egg is, where eggs can be purchased relative to the user's location, how to crack an egg, etc. The additional multimedia information can be the same type provided by the multimedia information processing unit or a different type. For example, while the multimedia initially presented in the example above is video, the additional multimedia information provided by processor 18 can also be video or may be text, images (e.g., photographs), audio, or information indicating that other users are currently watching a similar multimedia presentation shared via network 22.

Steps 208 through 216 are repeated until the multimedia information initially displayed is finished or is interrupted by user 10. In the example above, steps 208 through 216 may be repeated until the cake is covered with icing and decorations and is ready for consumption.

It should be noted that a user may be at a particular point in a process corresponding to a certain point in a multimedia presentation before a request from a user is input to multimedia processing unit 18 to view the multimedia presentation. For example, a user may be in the process of making a cake and realize that they don't know how to whip cream for icing. The user can request help from multimedia processing unit via one or more of input devices 22-30. For example, a user can ask “How do I whip cream for icing?” and multimedia processing unit 18 can interpret the question and provide the user with a list of relevant multimedia information as described above. Multimedia processing unit 18 can also provide relevant multimedia information by analyzing the input from input devices 22-30 and determine what the user is trying to do and where in the process the user currently is without further input from the user. For example, via input devices 22-30, multimedia processing unit 18 may determine that the user has already baked a cake and currently has the ingredients for making icing on a table in front of the user. Multimedia processing unit 18 can determine that the user probably wants to make icing and provide relevant multimedia information based on the determination.

The display of multimedia information can be modified based on multimedia processing unit having information concerning a user. If a user is an expert chef, multimedia processing unit 18 can take this information into account when displaying a multimedia presentation to the expert chef concerning cooking activities. For example, since the user is an expert chef, multimedia processing unit 18 may disregard the fact that the expert chef is breaking eggs in a manner different than the one displayed in the multimedia presentation whereas a novice user would be provided with additional information pertaining to methods of breaking eggs. In one embodiment, a user identifies their level of expertise in various areas to the system via the user's user profile. A user's level of expertise may be determined based on criteria such as time required to complete a task or the time consistency of completing various stages of a task. A particular user's level of expertise may also be determined based on ratings for the particular user provided by other users.

The additional multimedia information presented to a user in step 216 may consist of audio and video of another user viewing the same or a similar multimedia presentation. For example, if more than one user is currently viewing a presentation concerning how to make a cake, and one user appears to be stuck on a point in the process, audio and video of another user's progress performing the same procedure may be presented to the user who is having trouble.

The multimedia information presented to the user is generated by multimedia processing unit 18 using information acquired via network 22.

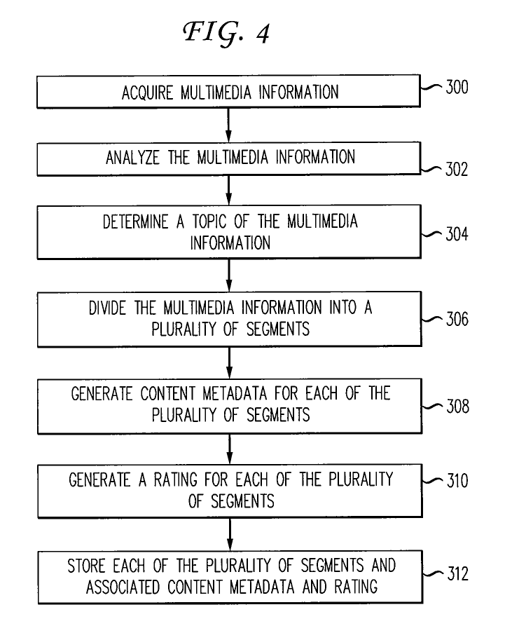

FIG. 4 depicts a flow chart of a method for acquiring and segmenting multimedia information according to one embodiment for use in generating new multimedia presentations using the segmented multimedia information.

Multimedia information is acquired from sources via network 22. At step 300, multimedia processing unit 18 acquires multimedia information. More specifically, multimedia processing unit 18 connects with various sources via network 22 and acquires (or downloads) multimedia information available from a particular source. Some examples of sources are individual users, businesses such as manufacturers of products, and media/content providers.

After multimedia information is acquired, at step 302, multimedia processing unit 18 analyzes the multimedia information before it is segmented for use in presentation to a user. Analysis of the content of the multimedia information depends on the type of multimedia information acquired.

Text information, in one embodiment, is analyzed by identifying terms in the text. For example, terms or keywords in the text can be identified and used to determine the topic of the text. Further, the occurrence and location of terms and/or keywords can be used to determine the topic to which the text pertains. Text information can be segmented, in one embodiment, by identifying headings and paragraph layout. Text information can alternatively or additionally be analyzed using other techniques to determine the content of the text.

Images, in one embodiment, are analyzed to determine what a particular image depicts. People in an image may be identified using facial recognition. Object recognition may be used to determine various items or objects displayed in the image. Recognition can also be used to determine the environment, scene, or location displayed in the image. Further, metadata associated with the image can be used to determine multiple pieces of information such as time and date a picture was taken, the location of the camera when the picture was taken, as well as additional information depending on the content of the metadata associated with the image.

Videos, in one embodiment, are analyzed in a similar manner to the method described above for images. Since video is basically a series of images, each image can be analyzed as described above in connection with image analysis. Various techniques can be used to lessen the time and processing requirements for analyzing video. For example, every 24^{th} image of a video may be analyzed instead of every image. In addition, a certain number of images per scene may be analyzed to lessen time and processing requirements. Other techniques, such as scene change detection may also be employed to analyze images only if a scene changes in order to effectively capture representative snapshots of the video with minimal redundancy.

Audio information, in one embodiment, is converted to text and then analyzed as text as described above. In another embodiment, audio is analyzed directly for event-based sounds and environmental sounds to produce relevant metadata.

It should be noted that multimedia information often consists of a combination of media. For example, most video has associated audio. For multimedia comprising a combination of media, one or more of the analysis methods may be used to analyze the multimedia information.

In addition to analysis of the content of the multimedia information, in one embodiment, information concerning the multimedia information is obtained from analyzing metadata associated with the information. For example, metadata associated with text such as date created, date modified, and author of the text may be used to aid in the analysis of the multimedia information. Images, video, and audio may also have metadata associated with the media identifying similar information as well as additional information such as data pertaining to geographic information (e.g., geotags).

At step 304, multimedia processing unit 18 determines a topic of the multimedia information. Information derived from analysis of the multimedia information is used to determine the topic of the multimedia. For example, for text media, the title of the text provides an indicator of the topic of the text. For images, the content of the image may be used to determine the topic or message conveyed by the image based on people identified in the image, the location the image was taken, objects identified in the image, and the caption of the image if one were available. The topic of the video may be determined in a similar manner to images as described above since video is a sequence of images.

At step 306, multimedia processing unit 18 divides the multimedia information into a plurality of segments. This dividing, or segmentation, is based on information derived in the analysis of the multimedia information of step 302 and/or the topic determination of step 304. For example, an instructional video may be segmented based on the steps presented. The steps of the procedure may be determined using the information derived from the analysis of the multimedia information in steps 302 and 304. Further, additional information available may be referenced in order to determine steps in a procedure in order to determine how the multimedia information should be segmented. For example, if an instructional video for showing a user how to make a cake is to be segmented, other information such as recipes can be referenced in order to determine how the instructional video can be segmented.

At step 308, multimedia processing unit 18 generates content metadata for each of the plurality of segments. The content metadata indicates what content a particular segment contains and is associated with that particular segment. For example, one segment of an instructional video for making a cake may be breaking eggs and placing the contents of the eggs into a bowl. Content metadata for that segment contains information identifying the segment as pertaining to a method for breaking eggs and placing the contents of the eggs into a bowl. The content metadata may also identify the particular method used in cases where more than one method is possible.

At step 310, multimedia processing unit 18 generates a rating for each of the plurality of segments. Ratings may be based on various factors including the author of the multimedia information, the fidelity of the information, and ratings and/or comments provided by people who have accessed the multimedia information. For example, many content providers allow people to rate content that they have accessed. People may also leave comments concerning the content. An average rating for content generated by averaging all ratings provides an indication of the overall value and/or usefulness of the content. These types of ratings can be used to determine ratings for segments that have been derived from the content. In addition, comments concerning content can be used to modify segment ratings based on the rating of the overall content. For example, a comment from a user may indicate that one particular portion of the content is very good while other portions are average. The particular portion of the content that the user indicated as very good can be associated with the related segment of the multimedia information. Information derived from analysis of these comments can then be used to modify or adjust the rating of a segment related to the particular portion of the content that the user identified as very good. A rating can also be generated by monitoring the user's activity using sensors 22-30. For example, the user can indicate a thumbs up rating by speaking a comment or can gesture with their thumb pointing up and the speech or gesture can be captured and properly analyzed to mean a thumbs up rating for that segment. In another example, a rating determined by multimedia processing unit 18 may represent the difficulty or repeatability of the segment determined by the number of synchronizations (e.g. 106 of FIG. 2, 214 of FIG. 3) required by the user while watching the segment.

At step 312, multimedia processing unit 18 stores each of the plurality of segments and associated content metadata and rating. In one embodiment, each of the segments is stored in database 20 with additional metadata identifying the multimedia information from which each of the plurality of segments was derived as well as where the segment was originally located in the multimedia information.

It should be noted that the rating of segments can be modified based on a trust level designated for the provider or author of the multimedia information from which the segment is derived. For example, a manufacturer of devices may be considered authoritative concerning the devices made by the manufacturer. The information obtained from these manufacturers pertaining to their devices may be given a higher rating based on the high level of trust associated with the manufacturer. Further, information authored or obtained from individuals who are considered experts with respect to the information may be provided with a higher rating based on the high level of trust designated for the author. Trust levels, in one embodiment, are stored in database 20 for use in rating information.

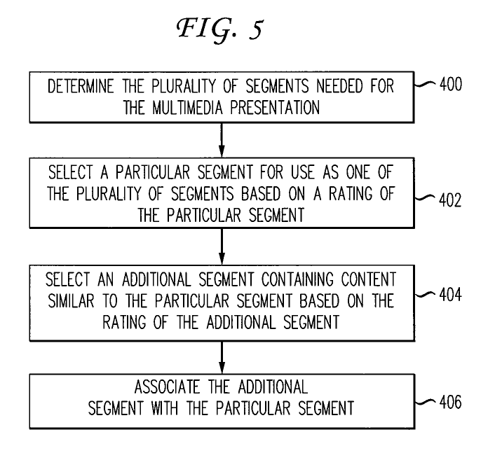

A multimedia presentation for display in the method of FIGS. 2 and 3 can be generated using segments derived from different multimedia information and generated using the method of FIG. 4. FIG. 5 depicts a method for generating a multimedia presentation by selecting a plurality of segments.

At step 400, multimedia processing unit 18 determines the plurality of segments needed for the multimedia presentation. For example, a multimedia presentation of an instructional video for making a cake may require various steps to be shown. The steps required for the presentation may be determined using information pertaining to a recipe for a specific cake or a combination of recipes for making a cake.

After the required steps for making the cake are identified, at step 402, multimedia processing unit 18 selects a particular segment for use as one of the plurality of segments based on a rating of the particular segment. More specifically, database 20 is searched for multimedia segments which pertain to each of the steps. For example, for a step requiring eggs to be broken and the contents placed in a bowl, database 20 is searched for segments related to breaking eggs and placing the contents of the eggs into a container. Since more than one multimedia segment pertaining to breaking eggs may be found, in one embodiment, the segment selected is the relevant segment having the highest rating. Other segments pertaining to other steps are similarly selected until all segments for the multimedia presentation are selected.

At step 404, multimedia processing unit selects an additional segment containing content similar to the particular segment based on the rating of the additional segment. The additional segment selected, in one embodiment, is the segment relevant to the particular step having the second highest rating.

After the additional segment is selected, at step 406 multimedia processing unit 18 associates the additional segment with the particular segment. The association of the additional segment may be identified in metadata associated with the related particular segment currently selected for use as one of the plurality of segments needed for the multimedia presentation. Further additional steps are similarly selected for each of the particular steps selected for use as one of the plurality of segments needed for the multimedia presentation. It should be noted that multiple additional steps may be associated with a particular segment. Additional steps for a particular segment may be selected to illustrate a variety of techniques which can be used for a particular step associated with a particular segment. For example, if several methods for breaking eggs and placing the contents in a container are available as multimedia segments, multiple additional segments may be associated with a particular segment in order to identify the multiple methods available. These associations, in one embodiment are identified in metadata associated with a particular step having the highest ratings. Alternatively, these associations may be identified in metadata of each of the multiple segments pertaining to various methods for performing the same procedure.

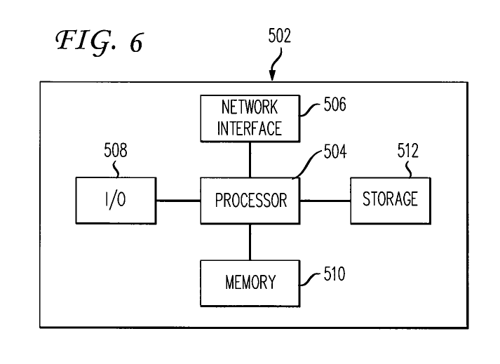

Multimedia processing unit 18 and the methods depicted in FIGS. 2, 3, 4, and 5 may be implemented using a computer. A high-level block diagram of such a computer is illustrated in FIG. 6. Computer 502 contains a processor 504 which controls the overall operation of the computer 502 by executing computer program instructions which define such operation. The computer program instructions may be stored in a storage device 512, or other computer readable medium (e.g., magnetic disk, CD ROM, etc.), and loaded into memory 510 when execution of the computer program instructions is desired. Thus, the method steps of FIGS. 1, 2, 3, and 4 can be defined by the computer program instructions stored in the memory 510 and/or storage 512 and controlled by the processor 504 executing the computer program instructions. For example, the computer program instructions can be implemented as computer executable code programmed by one skilled in the art to perform an algorithm defined by the method steps of FIGS. 2, 3, 4, and 5. Accordingly, by executing the computer program instructions, the processor 504 executes an algorithm defined by the method steps of FIGS. 2, 3, 4, and 5. The computer 502 also includes one or more network interfaces 506 for communicating with other devices via a network. The computer 502 also includes input/output devices 508 that enable user interaction with the computer 502 (e.g., display, keyboard, mouse, speakers, buttons, etc.) One skilled in the art will recognize that an implementation of an actual computer could contain other components as well, and that FIG. 5 is a high level representation of some of the components of such a computer for illustrative purposes.

Certain devices for displaying multimedia presentations to a user may have capabilities, such as orientation sensing, which enable the devices to assist in the presentation. For example, a mobile device displaying a multimedia presentation concerning fixing or adjusting a faulty device may be capable of determining its orientation with respect the faulty device. Using this orientation information, the device may display the multimedia presentation in a manner consistent with the orientation of the device with respect to the faulty device. This is useful since it can be used to provide the user with a display oriented in the same manner as the faulty device and prevents a user from having to determine how to perform tasks on a faulty device displayed at an orientation different from an image of the device in the multimedia presentation.

The foregoing Detailed Description is to be understood as being in every respect illustrative and exemplary, but not restrictive, and the scope of the general inventive concept disclosed herein is not to be determined from the Detailed Description, but rather from the claims as interpreted according to the full breadth permitted by the patent laws. It is to be understood that the embodiments shown and described herein are only illustrative of the principles of the general inventive concept and that various modifications may be implemented by those skilled in the art without departing from the scope and spirit of the general inventive concept. Those skilled in the art could implement various other feature combinations without departing from the scope and spirit of the general inventive concept.

1. A method for displaying a multimedia presentation to a user comprising:
presenting the multimedia presentation to the user;
sensing user activity;
comparing the user activity to metadata associated with the multimedia presentation;
adjusting the multimedia presentation based on the comparing.

2. The method of claim 1 wherein the adjusting comprises:
synchronizing a playback rate of the multimedia presentation to the user activity.

3. The method of claim 1 wherein the adjusting comprises:
presenting additional content to the user.

4. The method of claim 3 wherein the additional content comprises video and audio of another user viewing the multimedia presentation.

5. The method of claim 1 wherein the multimedia presentation comprises a plurality of segments, each of the plurality of segments selected based on a rating associated with each of the plurality of segments.

6. The method of claim 1 wherein the sensing user activity comprises sensing one of user motion, auditory information, manipulation of objects, and visual information.

7. The method of claim 5 wherein the rating associated with each of the plurality of segments is based on a level of trust associated with a provider of each of the plurality of segments.

8. An apparatus for displaying a multimedia presentation to a user comprising:
means for presenting the multimedia presentation to the user;
means for sensing user activity;
means for comparing the user activity to metadata associated with the multimedia presentation;
means for adjusting the multimedia presentation based on the comparing.

9. The apparatus of claim 8 wherein the means for adjusting comprises:
means for synchronizing a playback rate of the multimedia presentation to the user activity.

10. The apparatus of claim 8 wherein the means for adjusting comprises:
means for presenting additional content to the user.

11. The apparatus of claim 10 wherein the additional content comprises video and audio of another user viewing the multimedia presentation.

12. The apparatus of claim 8 wherein the means for sensing user activity comprises means for sensing one of user motion, auditory information, manipulation of objects, and visual information.

13. The apparatus of claim 8 wherein the multimedia presentation comprises a plurality of segments, each of the plurality of segments having a rating based on a level of trust associated with a provider of each of the plurality of segments.

14. A computer-readable medium having instructions stored thereon, the instructions for displaying a multimedia presentation to a user, the instructions in response to execution by a computing device cause the computing device to perform operations comprising:
presenting the multimedia presentation to the user;
sensing user activity;
comparing the user activity to metadata associated with the multimedia presentation;
adjusting the multimedia presentation based on the comparing.

15. The computer-readable medium of claim 14 wherein the operation of adjusting comprises:
synchronizing a playback rate of the multimedia presentation to the user activity.

16. The computer-readable medium of claim 14 wherein the operation of adjusting comprises:
presenting additional content to the user.

17. The computer-readable medium of claim 16 wherein the additional content comprises video and audio of another user viewing the multimedia presentation.

18. The computer-readable medium of claim 14 wherein the multimedia presentation comprises a plurality of segments, each of the plurality of segments selected based on a rating associated with each of the plurality of segments.

19. The computer-readable medium of claim 14 wherein the operation of sensing user activity comprises sensing one of user motion, auditory information, manipulation of objects, and visual information.

20. The computer-readable medium of claim 18 wherein the operation of rating associated with each of the plurality of segments is based on a level of trust associated with a provider of each of the plurality of segments.
